(19) United States
(12) Patent Application Publication
(10) Pub. No.: US 2009/0162623 A1
(43) Pub. Date: Jun. 25, 2009

(54) METHOD FOR SURFACE STRUCTURING OF A GLASS PRODUCT, GLASS PRODUCT WITH STRUCTURED SURFACE AND USES

(75) Inventors: Maud Foresti, Suresnes (FR); Elin Sondergard, Bourg La Reine (FR); Ludivine Menez, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 12/094,873

(22) PCT Filed: Nov. 14, 2006
(86) PCT No.: PCT/FR2006/051173

§ 371 Date: Oct. 7, 2008

(30) Foreign Application Priority Data
Nov. 23, 2005 (FR) 05 53576

(51) Int. Cl. B32B 3/10; C03B 23/00

(52) U.S. Cl. 428/210; 65/102; 65/286

(57) ABSTRACT

The invention relates to a process for structuring a surface, that is to say for forming at least one array of features with a submillimeter-scale lateral characteristic dimension on a plane surface of a product comprising a rigid glass element (1) and at least one layer (1a) attached to said glass element (1), the structuring being carried out on said layer (1a) and a surface structuring, by plastic or viscoplastic deformation, being carried out by contact with a structured element called a mask (10) with application of pressure, the structuring taking place by a continuous movement, parallel to the surface, of the product and by a movement of the mask about an axis parallel to the plane of the surface of the product. The invention also relates to a glass product having a structured surface and to its uses.

The present invention relates to the field of surface structuring and in particular to a process for structuring a glass product, to a structured glass product and to its uses.

The structuring of materials represents considerable interest as it finds applications in many technological fields.

The creation of an array of geometric features gives a material a new and novel function without changing its volume composition and its volume properties.

The writing of a periodically replicated pattern has thus already been carried out on glass products (directly on the glass substrate or on a coating) for pattern features on a millimeter scale or even of the order of a tenth of a millimeter, especially by rolling, laser etching or chemical etching techniques.

For features having smaller characteristic dimensions, especially a width or period of a micron or submicron scale, the structuring techniques are largely lithographic techniques (optical lithography, electron beam lithography, etc.), used in microelectronics, for small integrated-optic components.

However, these techniques are unsuitable for processes for manufacturing bulk glass products for one or more of the following reasons:
their high cost;
their slowness (scanning) and their complexity (several steps);
the size of the features is limited (by the wavelength); and
the small size of the structurable surfaces.

A more recent alternative technology, commonly called embossing, is used to transfer an elementary feature, to be periodically replicated, from a mold to a soft layer deposited on a glass substrate.

This layer is structured by lowering a flat pressing die bearing the pattern to be replicated, the pattern generally being fixed by applying UV or heat.

The soft layer is typically a layer prepared by the sol-gel process starting from inorganic precursors.

This method is used to manufacture components for the telecommunications field or, in quite another field, glasses having hydrophilic layers. Thus, FR 2 792 628 teaches a hydrophobic glass obtained by molding a sol-gel material rendered hydrophobic, having reliefs (pits, craters or grooves).

The advantages of this technique over lithography processes are numerous.

In terms of cost, the same pressing die can be reused many times and, starting from a single model, can result in a large number of replicas.

In terms of rate, this is a process carried out in a single step, unlike the other, lithographic techniques that require some pattern development steps.

In terms of pattern size, the size of the features on the pressing die is the main parameter that limits the size of the desired features, unlike in optical lithography which is limited by the wavelength.

This known embossing technique using a flat pressing die is not yet satisfactory in terms of yield (manufacturing time and limitation of the number of operations) and its implementation is not satisfactory for large, rigid and brittle surfaces.

Thus, the object of the present invention is to provide a process for manufacturing a high-performance structured glass product that meets the industrial constraints: low cost and/or design simplicity and/or suitability for any size of surface and feature size.

The aim of this process is also to widen the range of structured glass products available, especially so as to obtain novel geometries with novel functionalities and/or applications.

For this purpose, the invention firstly provides a process for structuring a surface, that is to say for forming at least one array of features with a submillimeter-scale lateral characteristic dimension on a plane surface of a glass product, especially the main face of a flat product, this product comprising a rigid glass element and at least one layer attached to said glass element, the structuring being carried out on said layer, and the surface structuring by plastic or viscoplastic deformation being carried out by contact with a structured element called a mask and by exerting pressure, the structuring being performed by a continuous translational movement of said product and by a movement of the mask about an axis parallel to the plane of the surface of the product.

Thus, the surface structuring according to the invention is written through a relative movement of the mask with respect to the product or of the product with respect to the mask. For example, the mask or the product undergoes a translational movement (optionally combined with a rotational movement) parallel to the surface of the product.

In particular the product undergoes a translational movement and the mask a rotational movement, or any other movement which is not liable to prevent the product from running or from appreciably slowing it down.

Making the mask move may even induce or participate in the translational movement of the product.

The movement or movements are continuous but the contacting, and therefore the structuring, may be sequential.

The movement or movements may be at a constant speed, so as to guarantee reproducibility, or with one or more variable speeds adjusted so as to obtain various types of structuring.

Furthermore, since the structuring according to the invention takes place by movement, this makes it possible to increase the production rates by eliminating the mask tool positioning steps, i.e. typically the steps of lowering and raising the flat pressing die. Likewise, mask alignment is facilitated.

The structuring method according to the invention can be easily automated and combined with other conversion operations carried out on the product. The method thus simplifies the production sequence.

The method is suitable for the manufacture of products in high volume and/or on a large scale, especially glass products for electronics and especially windows for buildings or automobiles.

Of course, the manufacturing parameters (pressure, duration of contact, etc.) are adjusted according to the toughness of the glass element.

The speed of the movement and the duration of the contact, under pressure, between the product and the mask are adjusted according to the nature of the surface to be structured, in particular:
its viscosity and its surface tension; and
possibly according to the type of features desired (most faithful reproduction of the mask feature, or intentionally truncated reproduction, etc.).

Within the context of the invention, the term “glass element” is understood to mean both a mineral (soda-lime-silica, borosilicate, glass-ceramic, etc.) glass and an organic glass (for example a thermoplastic polymer such as a polyurethane or a polycarbonate).

Within the context of the invention, an element which, under standard temperature and pressure conditions, has a modulus of at least 60 GPa in the case of a mineral element and at least 4 GPa in the case of an organic element is said to be “rigid”.

The glass element is preferably transparent, in particular having an overall light transmission of at least 70 to 75%.

As regards the composition of the glass element, it is preferred to use a glass having a linear absorption of less than 0.01 mm⁻¹ in that part of the spectrum useful for the application, generally the spectrum ranging from 380 to 1200 nm.

Even more preferably, an extra-clear glass is used, that is to say a glass having a linear absorption of less than 0.008 mm⁻¹ in the spectrum of wavelengths ranging from 380 to 1200 nm. For example, a glass of the Diamant brand sold by Saint-Gobain Glass may be chosen.

The glass element may be monolithic, laminated or bi-component. After the structuring, the product may also undergo various glass conversion operations, toughening, shaping, lamination, etc.

The glass element may be thin, for example with a thickness of the order of 0.1 mm in the case of mineral glasses and 1 millimeter in the case of organic glasses, or thicker, for example with a thickness equal to or greater than a few mm or even cm.

Before its structuring according to the invention, the surface is not necessarily smooth and may have a structuring shape.

The pattern on the mask is not necessarily the negative of the replicated pattern. Thus, the final pattern may be formed with several masks or by several passes.

The mask may have several regions with pattern features that differ by their size (width or height) and/or their orientation and/or their distance.

Depending on the shape of the intended structuring, this method may not necessarily result in perfect geometric shapes. In particular in the case of angled features, the pattern may be rounded without impairing the required performance.

The structuring method according to the invention also makes it possible to achieve ever smaller characteristic feature dimensions on ever larger surfaces, with a tolerance on the texturing defects that is acceptable, that is to say that does not impair the desired performance.

The manufacturing process makes the structuring of a brittle material possible and provides novel geometries in large glass substrates.

During the structuring of the layer, the glass (mineral or organic) element remains rigid, its surface preferably not being made structurable.

In one advantageous embodiment, the lateral characteristic dimension of the feature, otherwise called its width, is less than 50 μm, preferably less than 10 μm and even more preferably of micron or submicron scale.

Advantageously, the structuring may be carried out continuously on a product having an area equal to or greater than 0.1 m², even more preferably equal to or greater than 5 m². In particular, the width of the product may be equal to or greater than 1 m.

Advantageously, the structuring is carried out on a certain surface called the contact surface with a contact width that may cover a plurality of features in the direction of said continuous movement.

The ratio of the contact width to the lateral characteristic dimension, that is to say in the direction of said movement, is chosen to be between 50 and 10 000, especially between 100 and 1000, when the lateral dimension is of submicron scale.

The ratio of the contact width to the lateral characteristic dimension is chosen to be between 500 and 50 000, especially between 500 and 1000, when the lateral dimension is at least of micron scale.

Moreover, the length of the contact surface may be equal to or greater than 30 cm.

Advantageously, the mask may be curved. Now, the contact between the flat pressing die of the prior art and a product takes place plane to plane, so that this type of contact does not allow uniform distribution of the pressure—it is systematically lower at the center of the mask. Plane/plane contact also generates high stresses on the edges of the mold, fracture regions frequently occurring at this point.

With a curved mask, even if the area of the glass product to be structured is large, the contact area is small, thereby allowing better control of the contact zones. Since the structuring of the entire surface takes place progressively, in one or more bands, the deformable material is better able to fill the recesses in the mask, the air present in the cavities of the mask is expelled more and the replicated pattern is more faithful.

In a first configuration, the mask is fastened to a support that rotates about said axis parallel to the plane of the surface of the product and preferably chosen to be stationary, and the product preferably passes between the support and a rotary backing element.

The curved rotary support may for example be a simple cylinder or may have a surface partly falling within a circle, for example a polygonal surface. Moreover, the mask does not necessarily have replication features over its entire surface.

The rotation axis is not necessarily perpendicular to the direction of movement of the product.

The mask may be fastened to the support by one or more of the following means:
bars bolted to the support;
rings;
magnets, in sufficient number to press the mask against the support;
an electrostatic force product;
a vacuum product (by means of openings connected to a pump);
an adhesive material, a layer of a metal having a low melting point, a double-sided adhesive tape (modified polyester/acrylate resin) or a magnetized adhesive tape.

The ratio of the rotation speed of the mask to the run speed of the product is adjusted according to the necessary contact time for contact (under pressure) between the product and the structuring mask.

The structuring may take place preferably when the product passes between the support and a suitable rotary “backing” element, especially one of identical shape, but of different or identical size. The rotary support and the rotary “backing” element may have rotation speeds that are controlled by independent motors.

In particular, several—at least two—backing supports may replace the single rotary backing element, so as to distribute the pressure on the glass product.

The axis may be movable, especially one that undergoes a translational movement parallel to the surface of the product.

Thus, in a second configuration, the mask on its rotary support may roll over the surface of the product, exerting sufficient pressure thereon to structure it.

To avoid skidding and/or to drive the product, the mask may have a certain friction. Typically, friction bands may be produced on the sides of the support in order to guide it.

In a third configuration, the mask is movable and rotates about an axis which is parallel to the plane of the surface of the product and is preferably chosen to be stationary, the structuring taking place when the mask and the product are brought into contact with the application of pressure.

The mask is for example driven by a conveying system of the type consisting of rotating rollers, at least one of which, preferably in the central position, forms part of the pressing means.

For example, the movement of the mask forms an oval or an ellipse.

Moreover, it may happen that the surface of the mask used for the structuring makes a certain angle with the plane surface of the product.

Thus, the surface of the layer and the surface of the mask used for the structuring may preferably be kept (automatically) parallel during contact by means coupled to the mask support, especially a suspension system.

During structuring, the surface of the mask may be deformed, especially compressed or sunken, for a certain amount of compliance, preferably on several scales: local, therefore on the scale of the feature, and/or on a larger scale, especially the scale of the corrugations of the substrate.

This thus improves the quality of the contact by locally accommodating dust particles or imperfections, for example, on the surface of the product (defects, etc.) and/or its possible corrugations.

The smaller the features of the mask, the larger the interactions with the surface of the product, since the area of the mask in contact with the surface of the product increases. Furthermore, the surface of the mask may be oxidized.

In addition, to address these two possible mask contamination effects, the plane surface and/or the mask may advantageously include a nonstick agent of the surfactant type.

For this purpose, a fluorosilane layer may be grafted onto the surface of the mask or of the substrate before use, as described in the publication entitled “Improved anti-adhesive coating for nanoimprint lithography” by S. Park, J. Gobrecht, C. Padeste, H. Schift, K. Vogelsang, B. Schnyder, U. Pieles and S. Saxer, Paul Sherrer Institute Scientific Reports, 2003. This layer preferably does not exceed a few nanometers in thickness and therefore does not risk modifying the features, even of submicron scale, by filling the cavities in the mask. The nonstick layer thus formed also allows the mask to be used several times.

The structuring is carried out (optionally after the glass element has been structured) on at least one layer attached to said glass element.

This layer to be structured may be attached by adhesive bonding, etc. or, preferably, may be deposited on said glass substrate. This layer forms part of a multilayer stack on the glass substrate.

This layer may be a mineral, organic, especially polymeric, or hybrid layer and may be filled with metal particles.

This layer may be perfectly transparent, for example with an optical index greater than that of a glass (typically around 1.5).

This layer may be dense or may be porous or mesoporous.

The layer or layers may be obtained in particular by a sol-gel process, comprising for example the following steps:
the maturing of a precursor sol for the constituent material of the layer, of oxide type, especially a hydrolyzable compound such as a silicon alkoxide or halide, in a solvent, especially an aqueous and/or alcoholic solvent; and
the condensation of the precursor and the possible removal of the solvent so as to increase the viscosity.

Many chemical elements may form the basis of the sol-gel layer. It may comprise as essential constituent material, at least one compound from at least one of the elements: Si, Ti, Zr, W, Sb, Hf, Ta, V, Mg, Al, Mn, Co, Ni, Sn, Zn and Ce. It may in particular be a simple oxide or a mixed oxide of at least one of the aforementioned elements.

The layer may essentially be based on silica, especially for its adhesion to and its compatibility with the glass element.

To give an indication, at 600 nm, a silica layer typically has a refractive index of around 1.45, a titanium oxide layer has a refractive index of around 2 and a zirconia layer has a refractive index of around 1.7.

The precursor sol for the constituent material of the layer may be a silane or a silicate.

As purely inorganic layer, it is possible to choose a layer based on tetraethoxysilane (TEOS) or on lithium, sodium or potassium silicate, deposited for example by flow coating.

The layer may thus be a sodium silicate in aqueous solution, which is converted into a hard layer by exposure to a CO₂ atmosphere.

As hybrid layer, it is possible to choose a layer based on methyltriethoxysilane (MTEOS), an organosilane having an unreactive organic group. MTEOS is an organosilane which possesses three hydrolyzable groups and the organic part of which is a nonreactive methyl. It allows thick layers to be produced. The synthesis of the sol based on this compound is extremely simple since it is carried out in a single step and requires no heating. In addition, the sol prepared is stable and can be kept for several days without gelling.

Organic or inorganic or hybrid components (colorants, photochromic materials, inorganic or hybrid nanoparticles) may be encapsulated into the sol-gel matrix.

The sol layer may be dense or may be porous or mesoporous, possibly structured by a pore-forming agent, especially a surfactant.

This synthesis may preferably be carried out in dilute aqueous solution at room temperature. This has the two advantages of reducing its environmental hazard and of involving an energy-saving process.

The sol-gel matrices may also be mesostructured using organic surfactants. Said matrices may also be functionalized.

The sol-gel process is for example described in the book by Brinker and Sherer (C. J. Brinker and G. W. Scherer, Sol-gel Science, Academic Press, 1990) which describes a process for synthesizing organic/inorganic hybrid materials. These hybrids may be prepared by hydrolysis of organically modified metal halides or metal alkoxides condensed with or without simple (unmodified) metal alkoxides. For example, siloxane-based organic/inorganic hybrids may be mentioned, in which difunctional or trifunctional organosilanes are co-condensed with a metal alkoxide, mainly Si(OR)₄, Ti(OR)₄, Zr(OR)₄ or Al(OR)₄. An example is ORMOCER(ORganically MOdified CERamic) products sold by the Fraunhofer Institute.

Mention may also be made of ORMOSIL (ORganically MOdified SILicate) and ORMOCER CERAMER (CERAmic polyMER) products sold by MicroResist Technology.

The organic group may be any organofunctional group. This may be a simple nonhydrolyzable group, which acts as network modifier. It may provide normal properties such as flexibility, hydrophobicity, refractive index or optical response modification. The group may be reactive (if it contains a vinyl, methacrylic or epoxy group) and react either with itself or with an additional polymerizable monomer.

The latter organic polymerization may be triggered for example by temperature or by a radiative treatment (photopolymerization).

The layer may also be composed of an imbricated organic/inorganic network formed from the reactive organic groups of two different organosilanes.

This synthesis is performed using an aminosilane (3-aminopropyltriethoxysilane) and an epoxysilane (γ-glycidoxypropylmethyldiethoxysilane) denoted by A and Y respectively. This product is used to strengthen the glass. The product crosslinks both by organic reaction between the epoxy and amine groups and by the inorganic condensation reaction of the silanols. This therefore results in the formation of two imbricated networks, one organic and the other mineral.

The sol-gels have the advantage of withstanding heat treatments (even at high temperature, for example an operation of the bending or toughening type) and of withstanding exposure to UV.

Preferably, the thickness of the layer to be structured is between 50 nm and 50 μm, and more preferably between 100 nm and 12 μm.

The sooner the structuring is carried out after deposition, the better is the result, in particular for sol-gels that evolve over time.

It is also possible to provide a step in which the deposition of said layer is carried out on the structuring line.

The preferred methods for depositing the organic layers are dip coating or spraying of the sol followed by spreading the drops by doctoring or brushing, or else by heating as described in particular in the article entitled “Thermowetting embossing of the organic-inorganic hybrid materials” by W—S. Kim, K-S. Kim, Y—C. Kim and B-S Bae, 2005, Thin Solid Films, 476 (1) 181-184. The chosen method may also be spin coating.

The structuring may be carried out on a multilayer preferably comprising an upper seed layer, preferably one that is electrically conducting for subsequent electrodeposition.

The surface of the layer may be structurable by at least one of the following treatments: heat treatment, radiation treatment (UV, IR, microwave), or by interaction with a controlled atmosphere (gas, for example CO₂, to fix sodium silicate layers).

The temperature reached on the surface can vary depending on the layer to be structured, on the structuring conditions (contact time, pressure, etc.). For example, a thermoplastic polymer is heated to above its glass transition temperature so as to be able to be formed by embossing.

The surface may be rendered structurable just before a contacting or by the contacting. Thus, the mask may be heated by means of a cartridge heater placed inside the support and/or inside a pressure means or between two backing supports. Temperature sensors may be employed so as to know the surface temperature of the product and/or of the mask at the contact surface.

The heating may be carried out by an infrared or halogen lamp or by a heated fluid.

The assistance (heat treatment, radiative treatment, etc.) may be maintained throughout part of the contact phase or may be cut off, or even reversed (cooling, etc.) so as to stiffen the product.

The entire contacting phase may take place at a temperature above room temperature.

Now, a layer is more or less capable of being structured and of retaining its structuring. In the case of sol-gels, the layer as deposited may be embossed at room temperature, but the cold-embossed features have a tendency to become indistinct, assuming that the layer is fluidized during the subsequent heating needed for stiffening.

Therefore, it is preferable to carry out the transfer at high temperature. However, the temperature must not be too high, otherwise the structure stiffens too quickly for the mask to be able to sink completely into the layer.

The structuring may preferably be carried out at a temperature between 65° C. and 150° C., preferably between 100° C. and 120° C., especially in the case of silane-based, especially TEOS-based, sol-gels.

The embossing pressure limit increases with temperature.

In order not to lose the structuring, the surface may be sufficiently hardened before the product separates from the mask.

Therefore the feature is preferably stiffened (or at least starts to stiffen) during contact and/or after contact, by at least one of the following treatments: heat treatment, radiation treatment, exposure to a controlled atmosphere, the treatment or treatments modifying the mechanical properties of the surface.

The stiffening may be initiated right from the start of contacting.

In the case of a thermoplastic polymer, especially a polymethylmethacrylate (PMMA), this is cooled during contact, so as to be set, preserving the structure of the mask and providing a faithful replica of the feature upon “demolding”.

In the case of photocrosslinkable polymers, it is exposure of the layer to UV that hardens the layer.

The features may be in the form of hollows and/or raised features, and may be elongate, especially mutually parallel and/or a constant distance apart (corrugated features, zig-zag features, etc.). The features may also be inclined.

The structuring forms for example an array of studs, especially prismatic studs, and/or an array of elongate features, especially of rectangular, triangular, trapezoidal or other cross section.

The structure may be periodic, pseudoperiodic, quasiperiodic or random.

The elongate features may be angled, for example in the form of an H, Y or L, especially for the purpose of a microfluidic application.

The surface may be structured several times, preferably continuously, using masks that may be similar or different, for example with a decreasing size of Features.

Furthermore, a feature may itself be structured.

For example, the structured surface is hydrophobic, the feature is of rectangular cross section, and is structured by rectangular (sub)features so as to enhance the hydrophobicity.

The two main surfaces of said product may be structured with similar or different features, either simultaneously or in succession.

The process may also include a step of depositing a layer on the structured surface followed by at least one new structuring operation.

The process is preferably carried out in a clean atmosphere (clean room, etc.).

In one embodiment, when the mask is organized into structuring domains having different features (differing by their shape or by one of their characteristic dimensions, especially the pitch p) and/or different feature orientations, the plane surface is structured in structuring domains.

In particular, several (identical or different) submasks may be used to form a large mask. This makes its manufacture easier and provides more flexibility (if necessary, one of the masks can be changed in the case of wear, or defects, etc.).

A step of depositing a conducting, semiconducting and/or hydrophobic layer, especially an oxide-based layer, may follow the structuring or the first structuring.

This deposition is preferably carried out continuously.

For example, the layer is a metal—silver or aluminum—layer.

It may be advantageous to provide a step of selectively depositing a conducting layer (especially an oxide-based metal layer) on the structured surface, on or between for example dielectric or less-conducting Features.

The layer, for example in particular a silver or nickel layer, may be deposited electrolytically. In the latter case, to form an electrode for the electrolysis, the structured layer may advantageously be a (semi)conducting layer or a dielectric layer of the sol-gel type, the layer being filled with metal particles, or else a multilayer with a conducting upper seed layer.

The chemical potential of the electrolytic mixture is adapted to make deposition preferential in the high-curvature zones.

After the layer has been structured, it is conceivable to transfer the array of features to the glass substrate and/or to an underlying layer, especially by etching.

The structured layer may be a sacrificial layer, which possibly is partly or completely removed.

The invention also relates to a structuring device for implementing the process as described above, which comprises a rotary element, accommodating on the scale of the features and/or corrugations of the substrate, said rotary element serving as support for the mask and/or as means for applying pressure on the mask, and a deformable mask for the accommodation.

The mask and the mask support may be made as a single piece, for example a hollow or solid roll.

This is possible by combining an element that can sink in on several scales into that face of the mask on the opposite side from the replication Features.

In the first (respectively second) aforementioned configuration in which the mask is stationary (respectively fastened), this element may be an intermediate element between the support and the mask.

In the third aforementioned configuration in which the mask is movable, this element may be on one of the pressure means.

This accommodating element, for example an annular member, may be:
based on a spring; or
based on a material of the textile type (organic or mineral, especially carbon or glass, fibers) or a felt; or
based on fiber or nonfiber, elastomeric technical foams, especially made of rubber, polyimide, nitryl, EPDM; or
pneumatic, comprising a bag filled with a fluid (liquid or gas).

The mask is made of a material compatible with the process conditions (resistance, heat, etc.), preferably made of metal, for example nickel. Only one part and/or zone of the mask may have features for the structuring.

The mask may also be made of an elastomer, especially PDMS (polydimethylsiloxane) optionally surface-treated with TMCS (trichloromethylsiloxane).

The invention also relates to a glass product that can be obtained by the process as described above.

This glass product has all the aforementioned advantages (low production cost, homogeneity of the feature, etc.).

Said features may be inclined to the surface.

The characteristic dimension, especially the width, of the feature is preferably of the micron or submicron scale, and the array preferably extends over an area at least equal to or greater than 0.1 m², even more preferably equal to or greater than 0.5 m².

The structured glass product may be intended for an application in electronics, in buildings or in automobiles, or for a microfluidic application with angled channels of width w between 10 and 800 μm and a depth w between 10 and 500 μm.

In particular, various, especially glazing, products may be mentioned, namely:
products having modified (“super” hydrophobic or hydrophilic) chemical properties;
optical products, especially for lighting or backlighting systems in LCD-type flat screens (reflective polarizer, element for redirecting the light toward the front, etc.), especially a light extraction means for a light-emitting device, for example optical products intended for display screen, illumination and signaling applications; and
products for buildings, especially solar and/or thermal control glazing that includes a diffraction grating which is diffracted in the infrared, of period p preferably between 200 and 1500 nm, or glazing for redirecting natural light, called daylighting glazing, which includes a grating that is diffractive or refractive in the visible, or period p preferably between 100 nm and 500 μm.

The grating may be a 3D grating or more specifically a 2D grating, one of the characteristic dimensions of the feature being practically invariant in a preferred direction of the surface.

The structure may be periodic, pseudoperiodic, quasiperiodic or random.

The surface on the opposite side from the plane surface may also be structured and/or covered with a functional layer.

The function and the properties associated with the structuring depend on the following characteristic dimensions:
the height h of the feature (the maximum height in the case of a number of heights) and the width w of the feature (maximum width in the case of a number of widths), and especially the h/w ratio;
the distance (the maximum distance in the case of several) d between features, and especially the w/d ratio, or the pitch p, i.e. the sum w+d.
   Preferably, in the present invention:
the distance d is between 10 nm and 500 μm;
the width w is between 10 nm and 50 μm or the aspect ratio w/d is between 2×10⁻⁵ and 5×10⁴; and
the ratio h/w is equal to or less than 5.

One, some or all of the characteristic dimensions may preferably be of the micron or submicron scale.

The structuring may induce physicochemical, especially surface energy, modifications. This structuring may thus induce superhydrophobicity (“lotus” effect). To modify the wetting, Features ranging in size up to one micron are possible.

For optical purposes, the glass product may have a partial transmission of the light emitted by a source or a number of sources, the overall extent of which is ≧100 cm².

The range of optical functionalities of the microstructured or nanostructured products is wide.

Certain applications will require nanostructured reliefs with a pitch p of around 100 nanometers, especially below 400 nm, in order to limit the diffractive effects (and to maintain the transparency of the glass product).

For example, the desired structures are gratings of lines with periods ranging from 80 nm to 400 nm.

The array according to the invention may comprise a grating of dielectric (transparent) lines or conducting lines, the pitch of which is less than the operating wavelength. The conductor may be a metal, especially aluminum or silver, for use in the visible spectral range. The height of the dielectric grating (assumed to be in relief) and the height of the metal grating are then defined.

Other grating configurations are possible:
the dielectric grating is covered with a uniform layer of metal (“double metal” grating and on the side walls);
the metal grating is placed on the features of the dielectric grating or between the features (the structure is said to be “raised”).

The dielectric features may be of the same material as the substrate supporting the entire structure. The dielectric features may be of lower index than that of the substrate.

A material of lower index than that of the substrate may be placed between the substrate and the dielectric grating. The structure is said to be “ribbed”.

If the pitch is substantially less than the operating wavelength, especially the visible wavelength, (for example half the wavelength), the grating operates as a reflective polarizer. The polarization S perpendicular to the plane of incidence (parallel to the metal lines) is preferably reflected to more than 90%, whereas the polarization \vec{p} (perpendicular to the lines and parallel to the plane of incidence) is transmitted at preferably between 80 and 85%.

The reflective polarizer may serve in other wavelength ranges, especially in the IR.

A backlighting system, which consists of a light source or backlight is for example used as source for backlighting LCD (liquid crystal display) screens. It turns out that the light thus emitted by the backlighting system is not sufficiently homogeneous and exhibits excessively large contrasts. Thus, a rigid diffuser associated with the backlighting system is therefore necessary to homogenize the light.

One satisfactory solution from the light homogeneity standpoint consist in covering the front face of the backlighting system with a sheet of plastic, such as a polycarbonate or an acrylic polymer, containing mineral fillers within it, the sheet having for example a thickness of 2 mm. However, since this material is sensitive to heat, the plastic ages poorly and the heat generated results in general in structural deformation of the plastic diffusing means, which specifically results in heterogeneity of the illuminance of the projected image in LCD screens for example.

It may therefore be preferable to have, as rigid diffuser, a glass substrate with a diffusing layer as described in Patent Application FR 2 809 496. This diffusing layer is composed of scattering particles agglomerated in a binder.

Generally associated with the rigid diffuser (on the observer's side, opposite the light source), are the following optical elements:
firstly, a thin plastic film, commonly called a diffusing film, formed from a plastic film, generally made of PET, having on its external face an organic layer sufficiently rough to make the rigid diffuser more diffusing, this plastic film furthermore being known to redirect the light toward the front, that is to say toward the normal to the diffuser;
then, a plastic film having a smooth inner face and an outer face with grooves having an apex angle of 90° so as to redirect the light even more toward the front; and, finally
a reflective polarizer for transmitting one polarization of the light and for reflecting the other polarization.

The structured glass product according to the invention may be a reflective polarizer for an LCD screen. This product improves the overall polarization of the light directed toward the liquid crystal screen by transmitting the polarization component matched to the LCD matrix and reflects the other polarization so that, by successive recycling of the unsuitable polarization component, the polarization efficiency is improved, thereby limiting absorption losses.

The reflective polarizer according to the invention may comprise what is called a low-index layer, having a refractive index n₂ between the structured grating and the glass substrate (preferably made of mineral material) having a refractive index n₁, the difference n₁−n₂ being equal to or greater than 0.1, preferably equal to 0.2 or higher.

This low-index layer serves to increase the useful spectral band of the grating.

The low-index layer may preferably be porous, deposited in particular on the first element or on the second element. This layer is preferably based on an essentially mineral material.

The porous layer may thus have most particularly an approximately homogeneous distribution through its entire thickness, from the interface with the substrate or with any sublayer, as far as the interface with the air or with another medium. The homogeneous distribution may most particularly be useful for establishing isotropic properties of the layer.

The pores may thus be of elongate shape, especially in the form of rice grains. Even more preferably, the pores may have an approximately spherical or oval shape.

Many chemical elements may form the basis of the porous layer. It may comprise, as essential constituent material, at least one compound from at least one of the elements: Si, Ti, Zr, W, Sb, Hf, Ta, V, Mg, Al, Mn, Co, Ni, Sn, Zn and Ce. It may in particular be a simple oxide or a mixed oxide of at least one of the aforementioned elements.

Preferably, the porous layer may be essentially based on silica, especially for its adhesion to and compatibility with a glass substrate.

The porous layer according to the invention may preferably be mechanically stable—it does not collapse even with high pore concentrations. The pores may also be easily separated from one another, to be well individualized. Furthermore, the porous layer according to the invention is capable of both excellent cohesion and mechanical strength.

The constituent material of the porous layer may be preferably chosen so that it is transparent at certain wavelengths. Furthermore, at 600 nm the layer may have a refractive index at least 0.1, and even more preferably 0.2 or 0.3, less than the refractive index of a layer of the same dense (pore-free) mineral material. Preferably, this refractive index at 600 nm may especially be equal to or less than 1.3, or equal to or less than 1.1 and even close to 1 (for example 1.05).

For information, at 600 nm a layer of nonporous silica typically has a refractive index of around 1.45.

Thus the refractive index may be adjusted according to the pore volume. To a first approximation, the following equation may be used to calculate the index:

n=fn₁+(1−f)nₚₒᵣₑ

where f is the volume fraction of the constituent material of the layer and n₁ its refracted index, and nₚₒᵣₑ is the index of the pores, generally equal to 1 if they are empty.

The volume proportion of pores of the porous layer may be between 10% and 90%, preferably equal to or greater than 50% or even 70%.

By choosing silica, it is easy to bring the index down to 1.05 over the entire thickness.

The porous layer may be formed using various techniques.

In a first embodiment, the pores are the interstices of a noncompact stack of nanoscale balls, especially silica balls, this layer being described for example in document US 2004/0258929.

In a second embodiment, the porous layer is obtained by deposition of a condensed silica sol (silica oligomers) densified by NH₃ vapor, this layer being described for example in document WO 2005/049757.

In a third embodiment, the porous layer may also be of the sol-gel type. The structuring of the layer in terms of pores is due to the sol-gel synthesis technique, which allows the mineral material to be condensed with a suitably chosen pore-forming agent. The pores may be empty or optionally filled.

As described in document EP 1 329 433, a porous layer may be produced from a tetraethoxysilane (TEOS) sol hydrolyzed in acid medium with a pore-forming agent based on polyethylene glycol tert phenyl ether (Triton) at a concentration between 5 and 50 g/l. The combustion of this pore-forming agent at 500° C. releases the pores.

Other known pore-forming agents are micelles of cationic surfactant molecules in solution, and optionally in hydrolyzed form, or micelles of anionic or nonionic surfactants, or of amphiphilic molecules, for example block copolymers. Such agents generate pores in the form of narrow channels or relatively round pores of small size between 2 and 5 nm.

The porous layer may have pores with a size equal to or greater than 20 nm, preferably 40 nm and even more preferably 50 nm.

The large pores are less sensitive to water and to organic contaminations liable to degrade their properties, especially optical properties.

The porous layer may be preferably capable of being obtained using at least one solid pore-forming agent. By choosing the size of the solid pore-forming agent judiciously it is possible to vary the size of the pores in the layer.

A solid pore-forming agent itself allows better control of the pore size, especially access to large sizes, better control of the organization of the pores, especially a uniform distribution, and better control of the pore content in the layer and better reproducibility.

A solid pore-forming agent may or may not be hollow, may be a monocomponent or a multicomponent, and may be of mineral or organic or hybrid type.

A solid pore-forming agent may preferably be in particulate, preferably (quasi)spherical, form. The particles may preferably be well individualized, thereby allowing the pore size to be very easily controlled. It does not matter whether the surface of the pore-forming agent is rough or smooth.

As hollow pore-forming agent, hollow silica beads may in particular be mentioned.

As nonhollow pore-forming agent, one-component or two-component polymer beads, especially with a core material and a shell, may be mentioned.

A polymeric pore-forming agent is generally removed so as to obtain the porous layer, the pores of which may have approximately the shape and the size of the pore-forming agent.

The solid, especially polymeric, pore-forming agent may be available in various forms. It may be stable in solution—typically a colloidal dispersion is used—or it may be in the form of a powder that can be redispersed in an aqueous or alcohol solvent corresponding to the solvent used to form the sol or to a solvent compatible with this solvent.

In particular, a pore-forming agent made of one of the following polymers may be chosen:
polymethylmethacrylate (PMMA);
methyl (meth)acrylate/(meth)acrylic acid copolymers;
polycarbonate, polyester or polystyrene polymers; or
a combination of several of these materials.

For the sake of integration, the reflective polarizer according to the invention may further include, on the face opposite the structured face (face turned toward the light source), a diffusing layer, preferably an essentially mineral layer, especially as described in Patent Application FR 2 809 496 and possibly a low-index layer (already described) directly beneath the diffusing layer.

This diffusing layer may be continuous, with a constant thickness or with thicker zones, for example bands facing the sources of the fluorescent tube type.

To increase the homogeneity, this diffusing layer may advantageously:
have an average thickness that varies according to the coverage zone on the surface; and/or
be discontinuous, for example by means of a variable covering density. For example, by producing an array of scattering disks (and/or any other essentially solid, especially geometric, feature) of size and/or spacing and/or thickness that can vary from one zone to another, thus making it possible to vary from a completely covered zone to a zone consisting of dispersed points, the transition being gradual or not.

This layer may include scattering particles in a binder, for example having a refractive index of around 1.5.

The binder may be preferably chosen from mineral binders, such as potassium silicates, sodium silicates, lithium silicates, aluminum phosphates and glass or flux frits.

The mineral scattering particles may preferably comprise nitrides, carbides or oxides, oxides being preferably chosen from silica, alumina, zirconia, titanium, cerium, or being a mixture of at least two of these oxides. The scattering particles have for example a mean diameter of between 0.3 and 2 μm.

It is also possible to incorporate particles that absorb ultraviolet radiation in the 250 to 400 nm range, said absorbent particles consisting of oxides having ultraviolet absorption properties chosen from one or a mixture of the following oxides: titanium oxide, vanadium oxide, cerium oxide, zinc oxide and manganese oxide.

In one example, the diffusing layer comprises a glass frit as binder, alumina as scattering particles and titanium oxide as absorbent particles in proportions of 1 to 20% by weight of the mixture. The absorbent particles have for example a mean diameter of at most 0.1 μm.

The glass product according to the invention may also be an element for redirecting the emitted light toward the front (toward its normal).

It may have, on its structured face, a repetition of at least one feature, especially a geometric feature, the features being distributed regularly or randomly, with a width of 50 μm or less, and the absolute value of the slope of which is on average equal to or greater than 10°, even more preferably 200 or even 300.

The feature is chosen from at least one of the following features:
an elongate feature, in the form of a hollow or relief, especially a prism with an apex angle approximately equal to 900, or a microlens;
a three-dimensional feature, in the form of a hollow or a relief, especially of the pyramidal type, preferably with a base having a width equal to or less than 50 μm and an apex angle of less than 140°, even more preferably less than 110°;
a feature of the Fresnel lens type.

Furthermore, on the optically smooth opposite face, this element for redirecting light toward the front may be associated with a rigid diffuser or comprise a simple diffusing layer (already described), or with a low-index layer (already described) and with an external diffusing layer.

The structured layer may therefore preferably have a refractive index higher than that of the glass substrate. The features may be contiguous, with a pitch of between 0.5 and 50 μm, preferably less than 5 μm.

The glass product according to the invention may also be associated with or integrated into at least one light-emitting device having an organic or inorganic electroluminescent layer, especially of the OLED or PLED type, or a TFEL device or a TDEL device.

As is known, certain devices having electroluminescent layers comprise:
a glass substrate;
a first electrode and a second electrode on one and the same face of the substrate, at least one of the two electrodes being transparent; and
an electroluminescent system with at least one electroluminescent layer inserted between the first and second electrodes.

With an inorganic electroluminescent layer, this is referred to as a TFEL (thin-film electroluminescent) system. In general, this system comprises a phosphor layer and at least one dielectric layer.

For example, the dielectric layer may be based on the following materials: Si₃N₄, SiO₂, Al₂O₃, AlN, BaTiO₃, SrTiO₃, HfO, TiO₂.

The phosphor layer may be composed for example of the following materials: ZnS:Mn; ZnS:TbOF; ZnS:Tb; SrS: Cu; Ag; SrS:Ce or oxides such as Zn₂SiO₄:Mn.

Examples of inorganic electroluminescent stacks are for example described in document U.S. Pat. No. 6,358,632.

The dielectric layer may be thick (with a thickness of a few microns). This is then referred to as a TDEL (thick dielectric electroluminescent) system. Embodiments of TDEL systems are given in document EP 1 182 909.

With an organic electroluminescent layer, the device is referred to as an OLED. OLEDs are generally divided into two large families depending on the organic material used. If the organic electroluminescent layers are polymers, the devices are referred to as PLEDs (polymer light-emitting diodes). If the electroluminescent layers are small molecules, the devices are referred to as SM-OLEDs (small-molecule organic light-emitting diodes).

An example of a PLED consists of the following stack: a layer of poly(2,4-ethylenedioxythiophene) doped with poly(styrene sulfonate) (PEDOT:PSS) of 50 nm and a layer of phenyl poly(p-phenylenevinylene) Ph-PPV of 50 nm. The upper electrode may be a layer of Ca.

In general, the structure of an SM-OLED consists of a stack of hole-injection layers, a hole-transport layer, an emissive layer and electron-transport layer.

An example of a hole-injection layer is copper phthalocyanine (CuPC), and the hole-transport layer may for example be N,N′-bis(naphthalene-1-yl)-N,N′-bis(phenyl)benzidine (alpha-NPB). The emissive layer may for example be a layer of 4,4′,4″-tri(N-carbazolyl)triphenylamine (TCTA) doped with (fac-tris(2-phenylpyridine)iridium) [Ir(ppy)₃]. The electron-transport layer may be composed of tris(8-hydroxyquinoline)aluminum (Alq₃) or bathophenanthroline (BPhen). The upper electrode may be a layer of Mg/Al or LiF/Al.

Examples of organic light-emitting stacks are for example described in document U.S. Pat. No. 6,645,645.

In a light-emitting device, the two electrodes are preferably in the form of electroconductive layers.

The device is a top-emitting device, a bottom-emitting device or a top-and-bottom-emitting device.

The electrode furthest away from the substrate may however be a metal sheet or plate and may furthermore form a mirror (especially made of copper, stainless steel or aluminum).

The electroconductive layer closest to the substrate, generally the bottom electrode, may be chosen to be transparent, especially with a light transmission TL equal to or greater than 50%, especially equal to or greater than 70% or even equal to or greater than 80%.

This electroconductive layer may be chosen from metal oxides, especially the following materials: doped tin oxide, especially fluorine-doped tin oxide SnO₂:F or antimony-doped tin oxide SnO₂:Sb (the precursors than can be used in the case of CVD deposition may be tin halides or organometallics associated with a fluorine precursor of the hydrofluoric acid or trifluoroacetic acid type), doped zinc oxide, especially aluminum-doped zinc oxide ZnO:Al (the precursors that can be used in the case of CVD deposition may be zinc and aluminum halides or organometallics) or gallium-doped zinc oxide ZnO:Ga or doped indium oxide, especially tin-doped indium oxide ITO (the precursors that can be used in the case of CVD deposition may be indium and tin halides or organometallics), or zinc-doped indium oxide (IZO).

More generally, it is possible to use any type of transparent electroconductive layer for example TCO (transparent conductive oxide) layers, for example with a thickness between 2 and 100 nm. It is also possible to use thin metal layers, for example made of Ag, Al, Pd, Cu or Au, and typically with a thickness between 2 and 50 nm.

Of course, for applications in which transparency is necessary both electrodes are transparent.

The electroconductive layer furthest from the substrate may be opaque, reflective and metallic, especially comprising a layer of Al, Ag, Cu, Pt or Cr obtained by sputtering or evaporation.

The structuring helps in extracting the light, thus making it possible to increase the luminous efficiency.

In a first configuration, the aim is to prevent light from being trapped between the electrodes.

For example, it is possible to choose to structure, by etching, the glass substrate surmounted by a sacrificial layer structured by the process according to the invention.

Next, the bottom electroconductive layer (either a monolayer or a multilayer), the light-emitting system and the top electroconductive layer, thus reproducing the structuring, are deposited directly. Optionally, the top electroconductive layer (the one furthest from the substrate) is planarized so as to avoid short circuits.

It is also possible to deposit an additional layer and to form a plane surface before the bottom electroconductive layer is deposited. Preferably, this additional layer may have a refractive index at least 0.1, or even at least 0.2, higher than the index of the glass substrate, for example a zirconia layer, especially of the sol-gel type.

Alternatively, it is possible to choose a glass substrate with a layer structured by the process according to the invention, for example a silica layer or a zirconia layer, especially of the sol-gel type.

The structured layer is surmounted either directly by the bottom electroconductive layer or surmounted by an additional layer with a plane surface. Preferably, the layer surmounting the structured layer may have a refractive index at least 0.1, or even at least 0.2, higher than the index of the structured layer, for example an SiNx layer of 1.95 index.

The structuring comprises at least one periodic grating of submicron width w, with a pitch p of between 150 nm and 700 nm and a height h of less than 1 μm, especially between 20 and 200 nm. When the light-emitting system is multichromatic, especially forming white light, the structuring preferably comprises a plurality of adjacent gratings, each having a submicron lateral dimension w and a height h of less than 1 μm, especially between 20 and 200 nm, these gratings having different pitches p of between 150 nm and 700 nm so as to extract a plurality of wavelengths.

These features may for example be long lines extending approximately from one edge of the substrate to the other, or short lines, with a minimum length of 50 μm, or else other features of circular, hexagonal, square, rectangular or oval longitudinal section (parallel to the surface) especially with an approximately rectangular, semicylindrical, frustoconical or pyramidal cross section.

Examples of OLED devices with structured gratings are given in the article entitled “Enhanced light extraction efficiency from organic light-emitting diodes by insertion of two-dimensional photonic crystal structure” by Y. Do et al., Journal of Applied Physics, Vol. 96, No. 12, pp. 7629-7636 or the article entitled “A high extraction-efficiency nanopatterned organic light-emitting diode”, by Y. Lee et al., Applied Physics Letters, Vol. 82, No. 21, pp. 3779-3781 which are incorporated here by reference. these products are produced using lithography techniques on small areas.

In a second configuration, as an alternative or in addition to the first configuration, the aim is to prevent light from being trapped in the glass substrate.

To do this, it is possible to choose for example to structure, by etching, the glass substrate surmounted by a sacrificial layer structured by the process according to the invention on that face of the glass substrate opposite the face that may be associated with a light-emitting system in order to form a light-emitting device.

Alternatively, it is possible to choose to use a glass substrate with a layer structured by the process according to the invention, for example a silica layer or a zirconia layer, especially of the sol-gel type, on that face of the glass substrate opposite the face that may be associated with a light-emitting system in order to form a light-emitting device.

Preferably, the features are made of a material having a refractive index equal to or lower than that of the glass substrate.

The array is periodic, the features having a micron-scale lateral dimension w, especially between 1 and 50 μm (typically around 10 μm) and being spaced apart by 0 to 10 μm.

In particular, these geometric features may for example be long lines, extending approximately from one edge of the substrate to the other, or short lines, with a minimum length equal to 50 μm, or else features of circular, hexagonal, square, rectangular or oval longitudinal section (parallel to the surface) and especially with an approximately rectangular, semicylindrical, frustoconical or pyramidal cross section (in the form of hollows or reliefs).

The features may be aligned or offset, to form a hexagonal array.

One example of an OLED device with an array of microlenses is described entitled “Improved light-out coupling in organic light-emitting diodes employing ordered microlens arrays” by S. Moller et al., Journal of Applied Physics, Vol. 91, No. 5, pp. 3324-3327 incorporated here by reference. These products are produced using lithography techniques on small areas.

The glass product according to the invention may also be associated with a light-emitting device having one or more discrete sources of the LED (light-emitting diode) type. In this configuration, the diodes are placed on and/or bonded to a glass substrate with one or more arrays as described in the case of the first and/or second configuration.

Other details and advantageous characteristics of the invention will become apparent on reading the examples illustrated by the following figures:

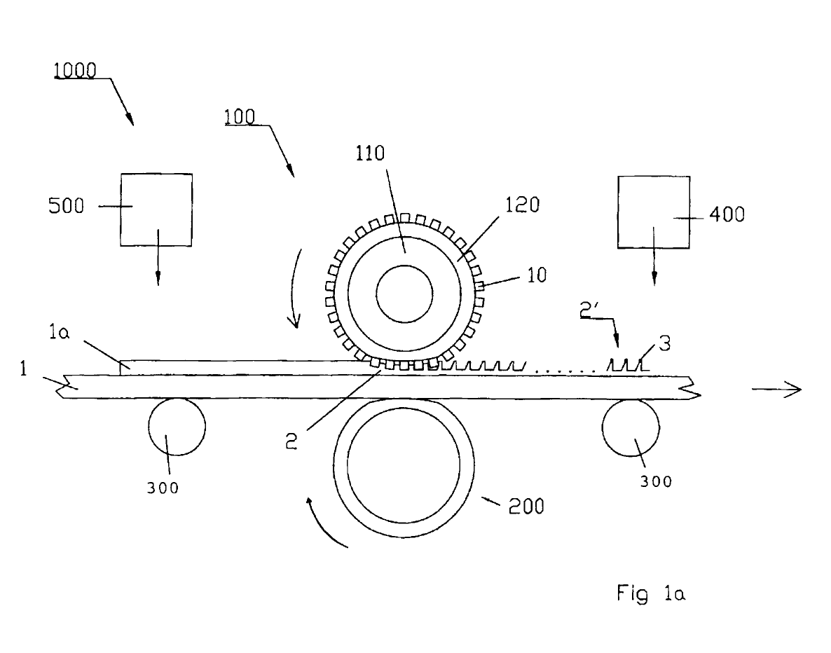

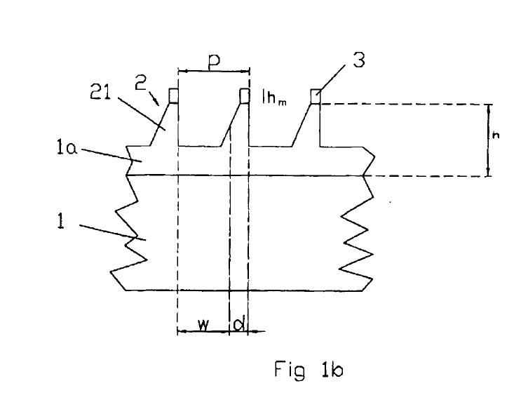

FIG. 1a shows schematically a first device for implementing the process for structuring a glass product in a first embodiment of the invention;

FIG. 1b shows respectively a partial sectional view of a structured glass product;

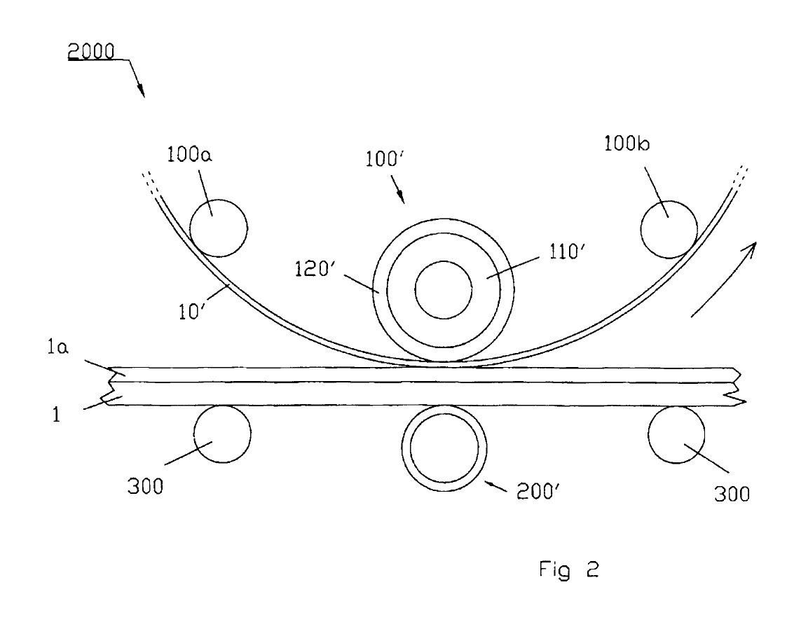

FIG. 2 shows schematically a second device for implementing the process for structuring a glass product in a second embodiment of the invention;

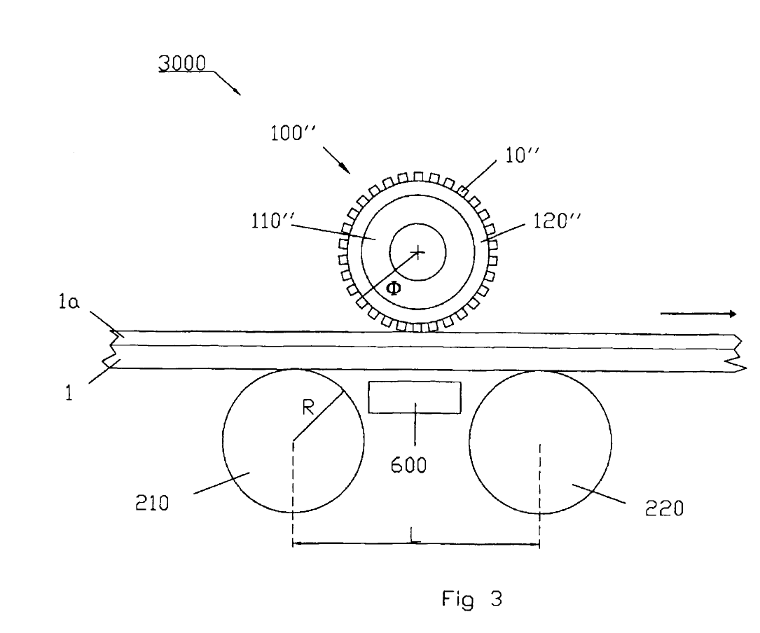

FIG. 3 shows schematically a third device for implementing the process for structuring a glass product in a third embodiment of the invention; and

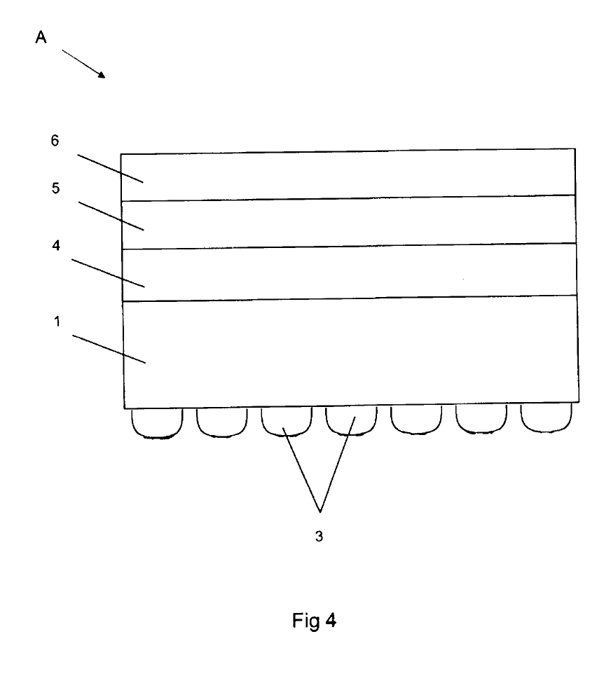

FIG. 4 shows schematically a structured glass product obtained using the manufacturing process described in FIG. 1a.

FIG. 1a shows schematically a first device for implementing the process for structuring a glass product according to the invention in a first embodiment.

This device 1000 is for example used to structure a rigid glass element 1, especially a glass sheet, covered with at least one essentially mineral, or organic, especially polymeric, or hybrid, structurable layer 1a (optionally with other subjacent layers), for example obtained by the sol-gel route, or made of a thermoplastic polymer.

Thus, this structurable layer is preferably transparent and may have other characteristics or functionalities: it may be (meso)porous, hydrophobic, hydrophilic, of low or high index, electrically conducting, semiconducting or dielectric.

The device 1000 is mainly comprised of a roll 100 bearing a replication mask 10 and of a backing roll 200 for exerting pressure.

The roll 100 comprises a hollow or solid, metal cylindrical core 110 surrounded by a conformable membrane 120, for example a technical foam, possibly a fiber foam, or a felt, said membrane being locally conformable, preferably on several scales.

The backing roll 200 may also be surrounded by an accommodating membrane, for example a technical foam, possibly a fiber foam, or a felt.

The rotation axis of the roll 100 is parallel to the plane of the surface of the product, more precisely perpendicular to the direction of translational movement of the product.

The mask 10 is fastened for example by radial rings and is wound onto the membrane 120.

A thin fluorosilane layer (not shown) is grafted onto the surface of the mask 10.

The glass element 1 is driven in translational movement by conveyor rollers. The glass element is directly on the conveyor rollers 300 or, as a variant, is on a platform or on a conveyor belt. One of the conveyor rollers is replaced by the backing roll 200. The glass element 1 preferably has an area of 0.5 m² or higher.

The replication mask 10 is made of silicon or, as a variant, made of quartz, or made of an optionally transparent polymer, a polyimide, and may be covered with a silicon oxide layer. The mask may also be made of metal, for example nickel, or may be a composite. The mask 10 includes, for example, an array of parallel lines, the dimensional characteristics (especially, width, pitch and height) of which are preferably on a micron or submicron scale.

The array on the mask is transferred onto the structurable layer 1a by contact as the glass element 1 passes between the roll 100 and the backing roll 200, the hollows in the mask becoming regions in relief on the structurable layer.

To increase the uniformity of transfer over the entire length of the contact surface, especially on the edges, a suspension system (not shown) keeps the rotation axis of the support roll 100 parallel to the width of the glass element 1.

In the contact zone, the mask 10 completely or partly follows the deformation of the layer 120.

The structuring takes place over a certain contact width, which covers a plurality of features 2.

When the width of the features is of submicron scale, the width of the contact surface is for example 100 μm.

When the width of the features is of micron scale, the width of the contact surface is for example 1 mm.

Said replicated features 2 have an inclination 21 of a few degrees at most to the surface of the glass element 1, as shown in FIG. 1b. The inclination may be adjusted according to the viscosity of the material.

Both lateral faces may be inclined, and the features may be rounded, for example in the form of wavelets.

Following the structuring operation, a metallic layer, for example a silver layer, may be deposited, preferable continuously, on the structured face.

This deposition may be selective, for example the metallic layer 3 is deposited on the peaks of the line features.

For this purpose, the layer 1a may form an electrode for an electrodeposition using associated in-line means 400.

To give an example, a reflective polarizer is obtained that is reflective in the visible with a pitch p of 200 nm, a mid-height width w of 80 nm, a mid-height distance d of 120 nm, a dielectric height h of 180 nm and a metal thickness hm of 100 nm.

It is also possible to obtain a polarizer in the infrared, by increasing the dimensions.

Alternatively to metal deposition, or thereafter, one or more of the following steps may be carried out, preferably continuously:
the other face is structured, preferably by means of a similar device placed downstream on the same line, or, as a variant, the roll 200 comprises a mask;
a second structuring operation, preferably by means of a similar device placed downstream with replication features of smaller dimensions and/or of different orientation(s);
the features are transferred to the glass and/or to a subjacent layer by etching; and
one or more glass conversion operations: toughening, lamination, cutting, etc.

Moreover, before this structuring, one or more of the other following steps may be carried out, preferably continuously:
deposition of the structurable layer by in-line means 500;
possible deposition of one or more subjacent layers; and
even further upstream, formation of the glass element, for example by the float process.

The layer 1a may be rendered structurable by heat or radiative treatment or by interaction with a controlled atmosphere.

As a variant, the features may be stiffened during and/or after contact by at least one of the following treatments chosen according to the nature of the layer: heat or radiative treatment, or exposure to a controlled atmosphere.

### Examples of Layers

As examples of structurable layers obtained by a sol-gel process, three layers A, B, C based on the reaction of a silane belonging to different classes may be mentioned:
layer A is a purely inorganic tetraethoxysilane (TEOS) layer optionally structured by a surfactant;
layer B is a hybrid layer based on methyltriethoxysilane (MTEOS) and an organosilane having an unreactive organic group;
layer C is a layer composed of an imbricated organic/inorganic network formed from the reactive organic groups of two different organosilanes.

The deposition method chosen may be coating by spraying, and doctoring or brushing in order to spread the coating, possibly with heating if the coating is too viscous.

These layers are preferably structured hot. The layer may be heated by contact with the mask or by heat transfer with the plate, heating means being for example placed in the rotary backing element.

The structuring temperature is chosen to be equal to 100° C. for layers of type A and 120° C. for layers of type B and C. The temperature is controlled by means of a thermocouple associated with the heating element.

Before and/or during the demolding, the structure is set by a heat treatment.

As examples of polymeric layers, a PMMA polymeric layer or, as a variant, a PMMA/MMA bilayer may be mentioned.

The polymer used is supplied for example by Acros Organics. This is a PMMA of 15 000 g.mol⁻¹, the glass temperature T_{g} of which is 105° C. This PMMA is diluted in 2-butanone (C₄H₈O) giving surfaces of high quality (low roughness, smooth appearance) by spin coating deposition.

The minimum temperature level required for structuring the layer is 150° C. The temperature is controlled by means of a thermocouple associated with a heating element.

The temperature is brought to a value below the glass temperature of PMMA, demolding then taking place at 70° C.

As an example of a UV-crosslinkable layer, an organoalkoxysilane layer may be mentioned. Exposure to UV radiation right after contact induces the polymerization reaction in the resin, setting the features.

FIG. 2 shows schematically a second device 2000 for implementing the process for structuring a glass product 1 according to the invention in a second embodiment.

Instead of being fastened to a rotary support, the replication mask 10′ (the features are not shown) is movable and rotates about an axis parallel to the plane of the surface of the glass element. At least one system based on conveyor rollers 100a, 100b is used.

The structuring takes place when the mask 10′ and the superposed glass element are in contact under pressure, i.e. in this example they pass between the rolls 100′, 200′.

Accommodation remains possible, by mounting an accommodating membrane 110′, for example a tire, on the roll 100′ associated with the mask 10′.

FIG. 3 shows schematically a third device 3000 for implementing the process for structuring a glass product 1 according to the invention in a third embodiment.

FIG. 3 shows a modified version of the device 1000 in which the backing roll 100 has been replaced with two backing rolls 210, 220 separated by a distance L. Their radius R may be different from the radius φ of the printing roll 100″ with a cylindrical core 110″, a conformable membrane 120″ and a replication mask 10″.

This type of setup has the advantage of allowing the passage of radiation, so as to set the features, or the positioning of a heating element 600. The distance L may range from R to 4φ. In addition, this setup makes it possible to exert a different pressure on the two sides of the printing roll. This proves to be beneficial for better controlling the shape of the features and the demolding operation.

FIG. 4 shows schematically a structured glass product A produced according to the manufacturing process described in FIG. 1a and forming a light-emitting device.

This device A typically comprises, on a first, main face of a glass substrate 1, for example an extra-clear glass, a light-emitting system 5 between two electroconductive layers 4, 6 and, on the second main face, on the opposite side, a lenticular periodic array 3 of micron-scale lateral dimension w and height h less than 50 μm.

The light-emitting device A may be organic. The first face is coated in the following order:
optionally with an alkali-metal barrier layer, for example made of a silicon nitride or oxynitride, an aluminum nitride or oxynitride or a silicon oxide or oxycarbide;
with a first transparent electrode (either a monolayer or a multilayer);
with an organic light-emitting system (OLED) typically formed from:
   a layer of alpha-NPD,
   a layer of TCTA+Ir(ppy)₃,
   a layer of BPhen and
   a layer of LiF; and
with a second transparent, or reflective, electrode, especially made of metal, preferably in the form of an electroconductive layer, especially one based on silver or aluminum.

The light-emitting device A may be inorganic (TFEL device). The first face is coated, in the following order:
optionally with an alkali-metal barrier layer, for example a silicon nitride or oxynitride, an aluminum nitride or oxynitride or a silicon oxide or oxycarbide;
with a transparent bottom electrode (a monolayer or multilayer);
with an inorganic light-emitting system (TFEL device) typically formed from:
   a layer of Si₃N₄,
   a layer of ZnS:Mn and
   a layer of Si₃N₄; and
with a transparent or reflective top electrode in the form of an electroconductive layer, especially a metal layer, preferably based on silver or aluminum.

It is also possible to form, beneath the bottom electrode 4, at least one periodic array of submicron-scale lateral dimension w, with a pitch p between 150 nm and 700 nm and a height h of less than 1 μm, especially between 20 and 200 nm, in particular by structuring an optionally porous sol-gel layer, for example made of SiO₂, using the process.

1: A process for structuring a surface, that is to say for forming at least one array of features with a submillimeter-scale lateral characteristic dimension on a plane surface of a product comprising a rigid glass element (1) and at least one layer (1a) attached to said glass element (1), said structuring being carried out on said layer (1a), and the surface structuring by plastic or viscoplastic deformation being carried out by contact with a structured element called a mask (10, 10′, 10″) and by exerting pressure, said structuring being performed by a continuous translational movement of said product and by a movement of said mask about an axis parallel to the plane of the surface of the product.

2: The surface structuring process as claimed in claim 1, characterized in that the characteristic dimension is less than 50 μm and is of micron or submicron scale.

3: The surface structuring process as claimed in claim 1, characterized in that the surface (1) has an area equal to or greater than 0.1 m².

4: The surface structuring process as claimed in claim 1, characterized in that said structuring is carried out on a certain contact surface with a contact width that covers a plurality of features in the direction of said continuous movement, the ratio of the contact width to the lateral characteristic dimension, i.e. in the direction of said movement, is between 50 and 10 000 when the lateral dimension of the feature is of submicron scale and the ratio of the contact width to the lateral dimension is between 500 and 50 000 when the lateral dimension is at least of micron scale.

5: The surface structuring process as claimed in claim 1, characterized in that the mask (10, 10″) is fastened to a support that rotates about said axis parallel to the plane of the surface of the product and is chosen to be stationary, and the product (1) passes between the support and at least one rotary backing element elements.

6: The surface structuring process as claimed in claim 1, characterized in that the mask (10′) is movable and rotates about said axis, which is parallel to the plane of the surface of the product and is chosen to be stationary, said mask being driven by a system of rotary rolls, said structuring taking place when the superposed mask and product are brought into contact with application of pressure.

7: The surface structuring process as claimed in claim 1, characterized in that the surface of the product and the surface of the mask used for the structuring are kept parallel during contact by means coupled to the mask support.

8: The surface structuring process as claimed in claim 1, characterized in that, during structuring, the surface of the mask (10, 10′, 10″) is deformed so as to be locally accommodating, on the scale of the features, and/or accommodating on a larger scale of the corrugations of the substrate.

9: The surface structuring process as claimed in claim 1, characterized in that the surface of the layer and/or the mask (10, 10′, 10″) includes a nonstick agent of the surfactant type.

10: The surface structuring process as claimed in claim 9, characterized in that said layer (1a) is transparent and/or is dense or porous and/or is essentially mineral, or organic, polymeric, or hybrid, and/or is filled with metal particles and/or is obtained by a sol-gel route and/or is electrically conducting, semiconducting or dielectric.

11: The surface structuring process as claimed in claim 1, characterized in that said layer (1a) is obtained by a sol-gel route with a sol based on a silane or a silicate, and in that said structuring is carried out at a temperature between 65° C. and 150° C.

12: The surface structuring process as claimed in claim 1, characterized in that said structuring is carried out on a multilayer that includes, as upper layer, a seed layer.

13: The surface structuring process as claimed in claim 1, characterized in that said surface of the layer (1a) is made structurable by heat and/or radiative treatment and/or by interaction with a controlled atmosphere.

14: The surface structuring process as claimed in claim 1, characterized in that said structuring of said layer (1a) takes place at a temperature above room temperature.

15: The surface structuring process as claimed in claim 1, characterized in that the features are stiffened during contact and/or after contact by at least one of the following treatments: heat or radiative treatment or exposure to a controlled atmosphere.

16: The surface structuring process as claimed in claim 1, characterized in that said structuring forms an array of studs and/or an array of elongate features or an angled array in the form of an H, L or Y, the features (2) optionally being inclined.

17: The surface structuring process as claimed in claim 1, characterized in that a first structuring operation is carried out so as to form said features and in that at least a second texturing operation is carried out on said features.

18: The surface structuring process as claimed in claim 1, characterized in that, when the mask is organized in structuring domains each having different features and/or a different feature orientation, the plane surface is structured in structuring domains.

19: The structuring process as claimed in claim 1, characterized in that it includes a step of depositing another conducting, semiconducting and/or hydrophobic layer (3) on the structured layer (1a).

20: The structuring process as claimed in claim 1, characterized in that said structuring of the layer (1a) is followed by a step of selectively depositing a conducting layer (3) on features or between features, and/or by a step 35 of etching the glass substrate.

21: The structuring process as claimed in claim 20, characterized in that the selective deposition comprises the electrodeposition of a metallic layer (3).

22: A structuring device for implementing the process as claimed in claim 1, characterized in that it comprises an accommodating rotary element (120, 120′, 120″), accommodating on the scale of the features and/or of the corrugations of the substrate, serving as mask support or as means for applying pressure on the mask, and in that it includes a deformable mask (10, 10′, 10″) for the accommodation, the mask and the mask support optionally being made as one piece.

23: The structuring device for implementing the process as claimed in claim 22, characterized in that said accommodating rotary element (120, 120′, 120″) is chosen from at least one of the following elements: an element based on a spring, based on a textile-type material, on a felt, on a technical foam, or a pneumatic element, and in that the mask is made of an elastomer.

24: A structured glass product that can be obtained by the process as claimed in claim 1.

25: The structured glass product as claimed in claim 24, characterized in that said features (2) are inclined to the surface.

26: The structured glass product as claimed in claim 24, characterized in that the lateral characteristic dimension (w) is of micron or submicron scale, and the array extends over an area equal to or greater than 0.1 m².

27: The structured product as claimed in claim 24, characterized in that the features are defined by a height h, a width w and a distance d, the distance d being chosen to be between 10 and 500 μm, the ratio h/w being chosen to be equal to or less than 5 and the ratio w/d being chosen to be between 2×10⁻⁵ and 5×10⁴.

28: The structured product as claimed in claim 24, characterized in that it is intended to be used in buildings as solar and/or thermal control glazing that includes an infrared diffraction grating, glazing for redirecting natural light, or glazing to be used in automobiles or in electronics, or in a microfluidic application, or glazing having an optical functionality, or the infrared, or an element for redirecting light toward the front, a light extraction means for a light-emitting device, or hydrophobic or hydrophilic glazing.

29: The structured product as claimed in claim 24, characterized in that it comprises an array of elongate dielectric features (2) and of elongate metal features (3) which are adjacent and/or superposed on the dielectric features, and/or in that it includes an array of geometric features, the features being regularly or randomly distributed, with a width equal to or less than 50 μm, and the absolute value of the slope of which is on average equal to or greater than 10°.

30: The structured product as claimed in claim 24, characterized in that it includes a diffusing layer, in particular an essentially mineral layer, on the opposite side from the structuring and/or a layer having a refractive index less than that of the glass substrate placed beneath the structured layer and/or beneath the optional diffusing layer.

31: The structured product as claimed in claim 24, characterized in that it comprises at least one periodic array of submicron-scale lateral dimension w, with a pitch p between 150 nm and 700 nm and a height h of less than 1 μm, the features having in particular a rectangular cross section, said array optionally being in or on that face of the glass substrate which can be associated with a light-emitting system in order to form a light-emitting device, and/or in that it includes a period array of micron-scale lateral dimension w, with a height h of less than 50 μm, the particularly geometric features being aligned or offset so as to form a hexagonal array in or on that face of the glass substrate opposite the face that can be associated with a light-emitting system in order to form a light-emitting device.
